(19) United States
(12) Patent Application Publication
(10) Pub. No.: US 2006/0029039 A1
(43) Pub. Date: Feb. 9, 2006

(54) Method, apparatus, and article of manufacture for web-based control of a call server

(76) Inventors: K. Scott Ramey, Stittsville (CA); Michel Burger, Palo Alto, CA (US)

Correspondence Address: DOCKET CLERK, P.O. DRAWER 800889, DALLAS, TX, 75380, US

(21) Appl. No.: 10/662,603

(22) Filed: Sep. 15, 2003

Related U.S. Application Data
(63) Continuation of application No. 09/414,589, filed on Oct. 8, 1999, now abandoned.

(51) Int. Cl. H04L 12/66

(52) U.S. Cl. 370/352

(57) ABSTRACT

A method, apparatus, and article of manufacture for enabling a web application to communicate with a call server. A communication channel is provided between the web application and the call server. Data transferred over the communication channel is translated to a form each can understand. The data may be in the form of a call control command or a service control command. A call control command may be a conference call control command. Data may be translated to call server system format, or to web application format.

### BACKGROUND OF THE INVENTION

A. Field of the Invention

The present invention relates to controlling call server systems, and more particularly to methods, apparatus, and articles of manufacture for communication between a web application and a call server.

B. Description of the Related Art

A legacy telephone system typically includes a number of telephone sets coupled to a private branch exchange (PBX) by physical wiring. A call server resides in the PBX and handles many different call-related functions for the telephone sets. Call control functions, service control functions, and user interface functions are typically controlled by the call server. Although several of those call-related functions can be initiated by users of the telephone sets, many are generally inaccessible. More specifically, while the call server can be controlled by a limited number of commands available to a user, many additional commands can only be issued by system administrators using restricted access interfaces.

Call control functions, such as call connection, call disconnection, and connection of the members of a conference call, are typically performed by a call server in response to a command from a telephone set coupled to the telephone system. For example, such a command could be the act of dialing a telephone number. Service control functions, such as establishing a conference call, performing last number redial, and initiating a voice mail function can be performed by a call server in accordance with a “policy” applied to a user's telephone. A system administrator controls the policy, and thus controls which services are available to a user, by issuing commands to the call server through the restricted interface. Accordingly, users have a limited degree of control over the services available to them, which can typically be expanded only by contacting the telephone system administrator.

A need exists to expand the functionality of legacy telephone systems such that users thereof have greater control over their associated call server and telephone set. Thereby, users can access greater functionality without having to communicate requests to a telephone system administrator. Such a methodology increases the usefulness of legacy telephone systems by allowing them to be highly configurable by a user.

### II. SUMMARY OF THE INVENTION

Methods, apparatus, and articles of manufacture consistent with the principles of the present invention enable communication between a web application and a call server. A web application can be implemented anywhere, such as on a PC with a user interface, or on a server. The invention provides a channel over which the call server communicates with an IP network and the web application. The communications may include typical call server control commands, such as call control commands for controlling telephone calls or service control commands for controlling telephone services. The invention may reduce the call control commands to a small set of primitives. For example, the invention may reduce the call control commands to primitives based on a conference model. The invention also converts data communicated to the call server from the web application into a native call server protocol, and the data communicated to the web application is converted to a native web application protocol.

Another aspect of the principles of the present invention provides a system for web-based control of telephony functions comprising a call server, a web application, a user interface device, and a wrapper for providing a communication channel and translating data transferred through the channel. The wrapper may be located anywhere within the system where a web application communicates with a call server.

It is to be understood that both the foregoing general description and the following detailed description are exemplary and explanatory only and are not restrictive of the invention, as claimed.

### III. BRIEF DESCRIPTION OF THE DRAWINGS

The accompanying drawings, which are incorporated in and constitute a part of this specification, illustrate an embodiment of the invention and together with the description explain the advantages and principles of the invention.

FIG. 1 is a block diagram of a system for enabling a web application to communicate with a call server system consistent with the principles of the present invention;

FIG. 2 is a flow chart of the steps performed by a method for enabling a web application to communicate with a call server system consistent with the principles of the present invention;

FIG. 3 is a flow chart of the operation of a system for enabling a web application to communicate with a call server system consistent with the principles of the present invention;

FIG. 4 is a diagram of a graphical user interface of a web application for communicating with a call server system through a wrapper;

FIG. 5 is a diagram of a graphical user interface of a web application for communicating with a call server system through a wrapper;

FIG. 6 is a block diagram of a system for enabling a web application to communicate with a call server system consistent with the principles of the present invention;

FIG. 7 is a block diagram of another system for enabling a web application to communicate with a call server system consistent with the principles of the present invention; and

FIG. 8 is a block diagram of a system for enabling a web application to communicate with a call server system consistent with the principles of the present invention.

### IV. DETAILED DESCRIPTION

Reference will now be made in detail to an embodiment of the invention as illustrated in the accompanying drawings.

In the following description, for purposes of explanation, numerous specific details are set forth in order to provide a thorough understanding of the present invention. One skilled in the art, however, will realize that the present invention may be practiced without these specific details. In other instances, standard structures and devices are shown in block diagram form in order to facilitate description.

The present application is related to and incorporates by reference the U.S. patent application of K. Scott Ramey, Craig Will, and Larry David entitled METHOD, APPARATUS AND ARTICLE OF MANUFACTURE FOR WEB-ENABLING LEGACY TELEPHONE DEVICES filed on Oct. 8, 1999, attorney docket number 03384.0373-00000 and the U.S. patent application of K. Scott Ramey, Michel Burger, and Larry David entitled METHOD, APPARATUS, AND ARTICLE OF MANUFACTURE FOR WEB-BASED CONTROL OF A UNIFIED MULTI-PURPOSE COMMUNICATION SYSTEM filed on Oct. 8, 1999, attorney docket number 03384.0374-00000.

In one embodiment, steps according to the present invention are embodied in machine-executable software instructions, and the present invention is carried out in a processing system by a processor executing the instructions. Those skilled in the art will recognize that other embodiments, for example hardwired circuitry, may be used in place of, or in combination with, software instructions to implement the present invention.

As used herein, call server system is broadly defined as a collection of elements, including a call server, that function to control telephone calls and telephone services. Apparatus and methods consistent with the principles of the invention act as an interface between an IP network, such as the World Wide Web, and a legacy call server system, which lacks the ability to communicate over the IP network.

System Architecture

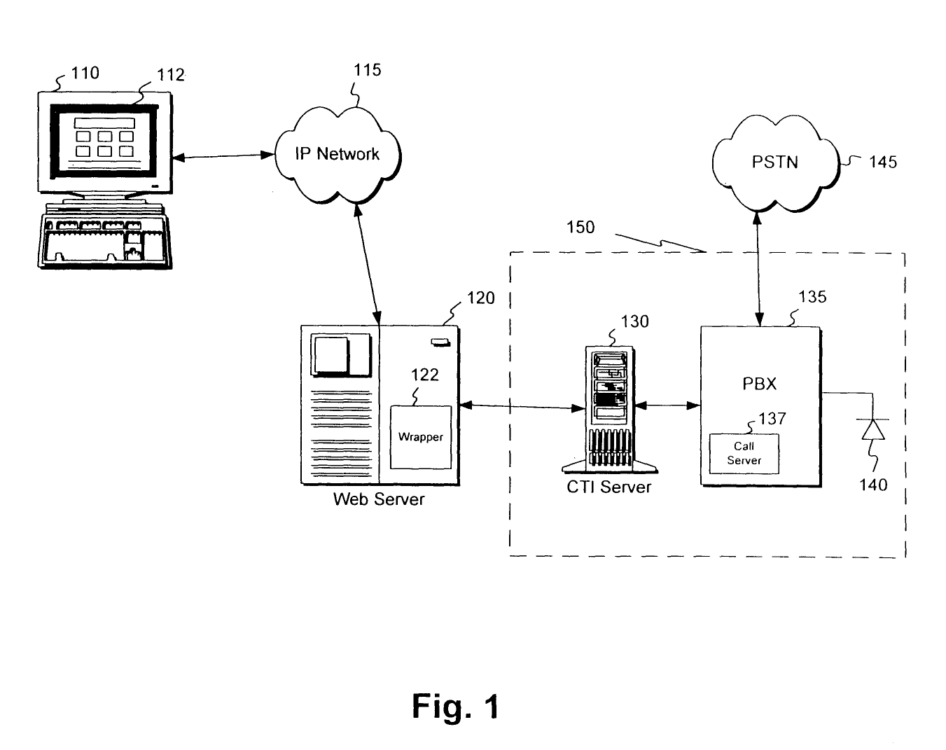

FIG. 1 shows a block diagram of a system for enabling a web application to communicate with a call server system consistent with the principles of the present invention. A telephony device 140 and a Public Switched Telephone Network (PSTN) 145 are connected to a Private Branch Exchange (PBX) 135 containing a call server 137. As is well known in the art, call server 137 controls the calls and services in PBX 135, making connections amongst and between telephony devices, such as telephony device 140 which are on the private telephone system and those coupled to the PSTN. Telephony device 140 makes and receives calls in a standard manner. In one embodiment, PBX 135 comprises a conventional legacy PBX, which lacks the ability to communicate with a web application over an IP network, such as the World Wide Web.

Call server 137 is communicatively connected to a computer telephony interface (CTI) server 130. CTI server 130 allows a computer to indirectly communicate with and control call server 137. CTI server 130 has a conventional application program interface (API) for communicating with external applications. The API may be a standards-based interface, such as the Telephony API (TAPI) developed by Microsoft or the Java TAPI (JTAPI) developed by Sun Microsystems, or the API may be a proprietary interface. By way of example, CTI server 130 is shown as a device separate from call server 137. CTI server 130 could, however, be implemented as part of call server 137, or as part of another server (not shown).

CTI server 130 is connected to a web server 120. In this embodiment, web server 120 includes a wrapper 122, which executes on web server 120. CTI server 130 communicates with wrapper 122. Web server 120 is connected to IP network 115.

A personal computer (PC) 110 executes a web application (not shown) that a user interacts with through user interface 112. A user can send data to and receive data from IP network 115 using the web application, and therefore can exchange data with wrapper 122 executing on web server 120. Conversely, wrapper 122 running on web server 120 can receive data from and transmit data to IP network 115, and therefore can exchange data with a web application program executing on PC 110. In another embodiment, a web application (not shown) runs on a server connected to IP network 115, instead of PC 110, and communicates through wrapper 122. In yet another embodiment, a web application running on PC 110 communicates indirectly with wrapper 122 by communicating through a web application (not shown) running on a server (not shown) connected to IP network 115, which acts as an interface, passing the communication on to wrapper 122.

Wrapper 122 thus links IP network 115 and CTI server 130, providing a communication channel between the web application executing on PC 110 and call server 137. In the embodiment of FIG. 1, the communication channel extends from the web application executing on PC 110, across IP network 115, through wrapper 122 executing on web server 120, through CTI server 130, to call server 137.

One skilled in the art will recognize that a call server system used with apparatus and methods consistent with the principles of the invention may comprise fewer elements. For example, a call server by itself is a single element call server system.

Wrapper Functions

For a web application and a call server system to communicate with each other, the web application must use an API provided by the call server system. As noted above, CTIs that provide API's for call servers employ many different formats of API's. Thus, a single web application cannot communicate with all types of call server systems. Apparatus and methods consistent with the principles of the present invention provide a single API for all call server systems, and translate data transferred between a web application and a call server system into formats compatible with each.

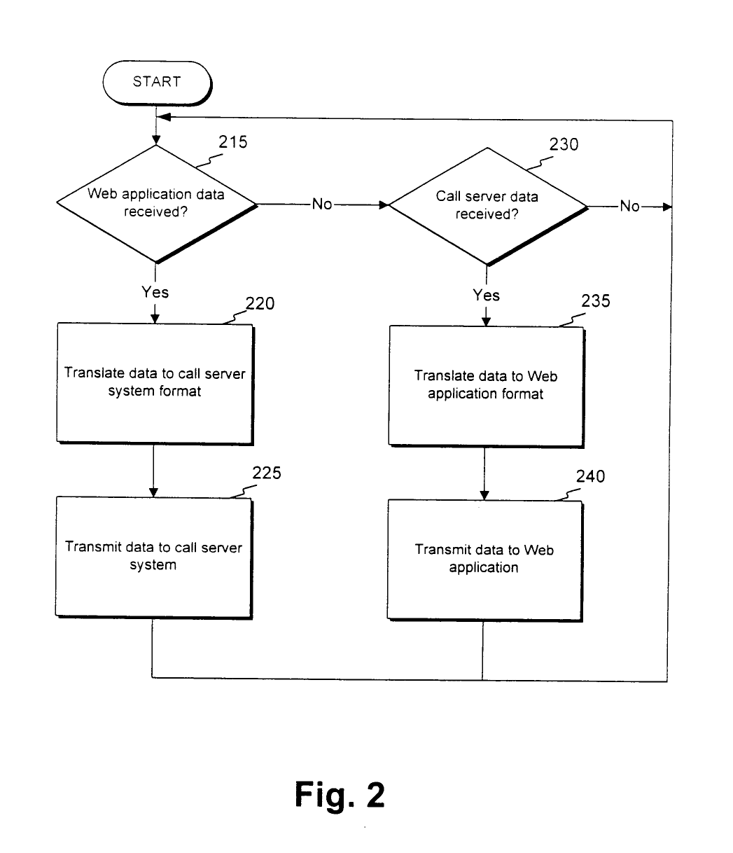

FIG. 2 is a flow chart illustrating the steps performed by wrapper 122 consistent with the principles of the present invention. Wrapper 122 first determines whether data was received from the web API executing on PC 110 that is intended for the call server (step 215). If such web application data was received, wrapper 122 translates the data from web application format to call server system format (step 220), and transmits the translated data to the call server entity handling the communication from the web application (step 225). Web application format is a format that wrapper 122 can receive and understand, as defined by wrapper 122's API, and which is used by a web application communicating with wrapper 122. Call server system format is a format used by a call server system. Processing then returns to determining whether additional web application data is received (step 215).

If web application data is not received (step 215), wrapper 122 determines whether call server data was received from the call server entity handling the communication from the web application (step 230). If call server data was received, wrapper 122 translates the data from call server system format to web application format (step 235), and transmits the translated data to the web application executing on PC 110 (step 240). Processing then returns to determining whether additional web application data was received (step 215).

Wrapper 122 handles translations between data in a web application format and data in a call server system format, allowing legacy call server systems to interact with web-enabled entities on IP network 115. In one embodiment, the data comprises commands which cause the call server to perform a function, or status information describing the state of a call server function.

One skilled in the art will recognize that the tasks of receiving and translating data from the call server system and the web application could be performed concurrently by a multi-tasking computing system without departing from the scope of the present invention.

Wrapper—Web Application Interface

Wrapper 122 comprises two interfaces: a web application program interface (API) through which it communicates with the web application executing, in this example, on PC 110, and a call server system interface through which it communicates with a call server system entity. Wrapper 122 provides a uniform user interface for call server systems, such as PBX's, and may be designed consistent with the present invention to operate with any model and manufacturer. Thus, wrapper 122 allows web applications and call server systems to interact with each other without reprogramming either end to provide data in a format specific to the other end.

The web API of wrapper 122, defines the web application data format. That is, the web API specifies the format of the data communicated between the web application and the wrapper. In one embodiment, the web API specifies that the web application data be in the format of a call control command. A call control command causes call server 137 to perform a function which controls a telephone call or is a response from call server 137. For example, a call control command may cause call server 137 to create a connection between two telephony devices, and call server 137 may send a responding call control command to indicate that a connection is established.

In one embodiment, the call server control commands are broken down into primitives. The number of primitives may be fewer than the number of call server control commands. Reducing the number of call control commands to a small group of primitives simplifies the wrapper user interface. Complex call control functions may be realized by using combinations of the call control command primitives.

For example, conference call control commands might include the primitives:
create_conference(id), which creates a communication context, identified by the id parameter, in the call server;
delete_conference(id), which deletes an existing communication context, identified by the id parameter, in the call server;
add_to_conference(id, user), which adds a user whose attributes, for example telephone number, are contained in the user parameter to an existing communication context, identified by the id parameter, in the call server;
delete_to_conference(id, user) which deletes a user identified by the user parameter from an existing communication context, identified by the id parameter, in the call server; and
notify(event) which reports status, using the event parameter, to the web application.

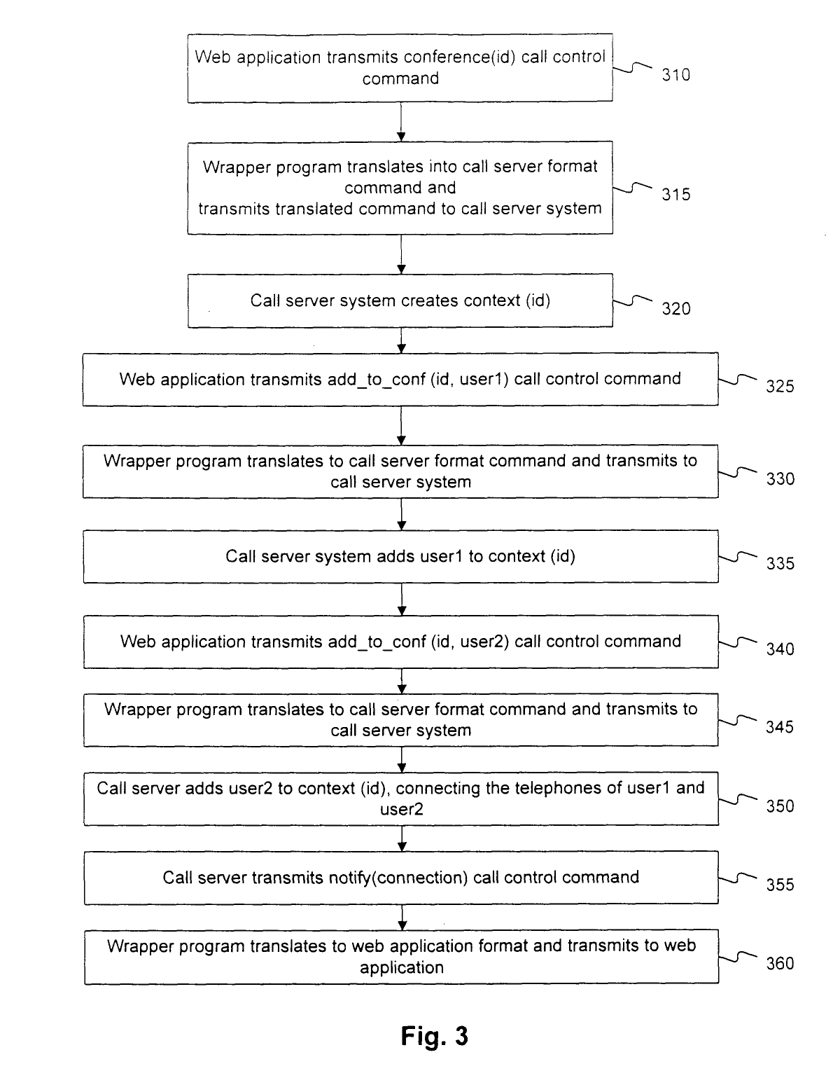

FIG. 3 is a flow chart of an example of the operation of a system for enabling a web application to communicate with a call server system consistent with the principles of the present invention. To set up a telephone call using the conference call control command primitives, a web application executing on PC 110 first transmits a create_conference(id) command to wrapper 122 (step 310). Wrapper 122 translates the command into a format compatible with call server system 150 and forwards the translated data (step 315). Call server 137 creates a context for a call, identified by the id parameter (step 320). Creating a context may involve, for example, reserving PBX resources. The web application then transmits an add_to_conference(id, user1) command, where the id parameter is the same and the user parameter identifies the source telephone (such as by its telephone number, an associated IP address or other identifier) (step 325). Wrapper 122 translates the command and forwards the translated data (step 330). Call server 137 adds user1 to the context identified by the id parameter (step 335). Next, the web application sends another add_to_conference(id, user2) command, where the id parameter is again the same, and the user2 parameter identifies the destination telephone (step 340). Wrapper 122 translates the command and forwards the translated data (step 345). Call server 137 adds user2 to the context identified by the id parameter (step 350). At this point, call server 137 acts to connect the two telephones identified by the user1 and user2 parameters (step 350), and transmits a notify(connection) command to the web application through the wrapper (step 355). The wrapper translates the data to web application format and transmits it to the web application (step 360). If the connection is successful, call server 137 may, for example, cause the user1 source telephone to ring. After the source telephone is picked up, call server 137 causes the user2 destination telephone to ring.

Those skilled in the art will recognize that the principles described herein apply to any call server functionality without departing from the spirit and scope of the invention. Thus, the principles may be applied to any call control commands providing various functions in addition to the functions noted above. For example, a reroute(id1, id2, user) conference call control command, which causes a call already connected to the user to be rerouted through another context could also be part of the web API without departing from the scope of the invention.

In one embodiment, the web API specifies that the web application data be in the format of a service control command. A service control command causes the call server to affect a telephony service for a telephony device. For example, the web API may include an add caller id(user) service control command, which enables a caller id service for the telephone identified by the user parameter. For another example, the web API may include a ring(user, ring) service control command, which changes the ring pattern according to the ring parameter for the telephone identified by the user parameter.

In one implementation, the web API follows the Jini device definition created by Sun Microsystems to allow easy network connection of a web-enabled call server system.

Wrapper—Call Server System Interface

The call server system that a wrapper communicates with defines the call server data format. That is, the call server system's interface specifies the format of the data communicated between the call server and wrapper 122. in one embodiment, the present invention converts data from a web application format into a call server system data format before transmitting the converted data to the call server system.

One aspect of the present invention is providing web-accessability to an installed call server, with little or no modification of the call server system. Returning to FIG. 1, many existing conventional call server systems, such as call server system 150, have a CTI server 130 installed. CTI server 130 provides hardware connections and an API for controlling call server 137. The API may be standards-based, such as Microsoft's TAPI, or may be a proprietary interface. A CTI may be realized on a stand-alone CTI server as shown in FIG. 1. In this embodiment, the call server system data format is defined by the CTI API, for example TAPI or JTAPI. The CTI may also be integrated into call server 137.

Web Application Program

A web application is any entity on IP network 115 capable of communicating with wrapper 122 on web server 120. In one embodiment, a web application communicates with the wrapper using a web application data format defined by the web API of wrapper 122.

In one embodiment, the web application is a Java applet running on a web browser on PC 110. The web browser loads a web page including the Java applet web application. The web page provides a graphical user interface (GUI) for control and presentation to the user. The web page may be loaded locally from PC 110, or it may be loaded from a remote computer, for example a web server which is accessed using a standard universal resource locator (URL). The web page accessed by the web browser could be in any standard browser-readable language, for example, hypertext markup language (HTML) or extensible markup language (XML), both using Hyper Text Transfer Protocol (HTTP).

In another embodiment, the web application is a stand-alone process running on PC 110, or on a separate web server (not shown). The stand-alone process communicates with the wrapper in web application data format in conformance with the web API. If the web application is located on a separate server, remote method invocation (RMI), or common object request broker architecture (CORBA) can be used to publish the web application interface. In still another embodiment, a web application, for example running on PC 110, may communicate indirectly with wrapper 122 on a path through another web application running on a web server (not shown). One skilled in the art will recognize that a web application could be implemented in a number of ways, such as a hard-wired circuit, and still be consistent with the principles of the present invention.

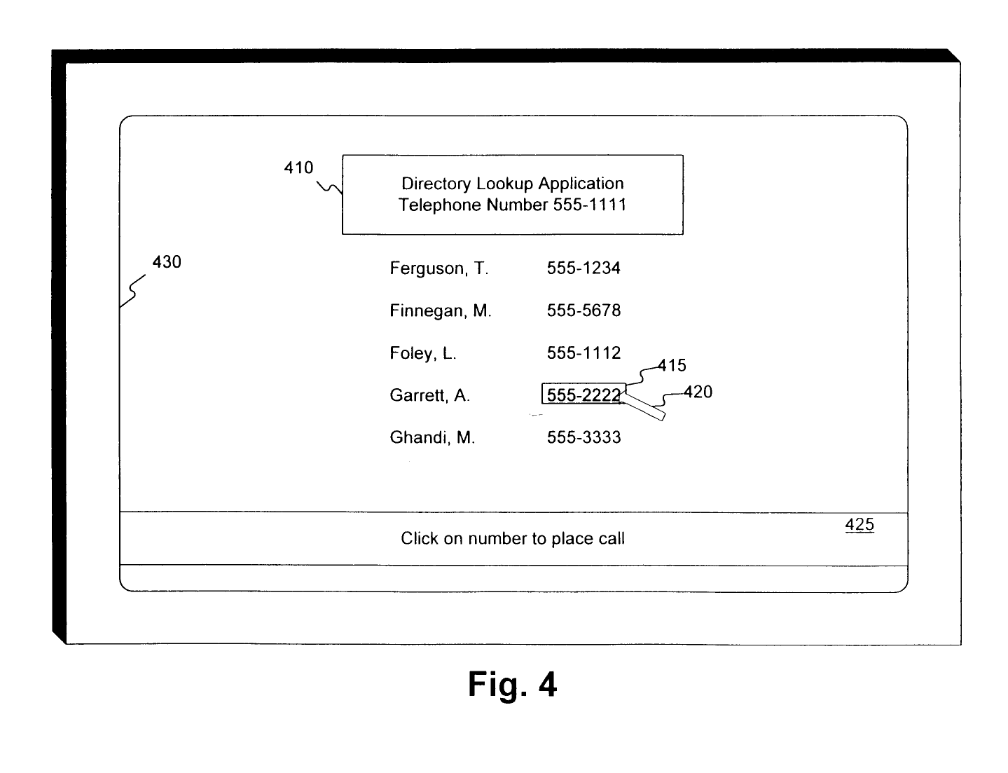

FIG. 4 shows an example of a web application graphical user interface 430 for a web browser running on PC 110. A title 410 shows that a user at telephone number 555-1111 is invoking a directory lookup web application on their web browser. In this example, the web application allows the user to select a telephone number from the directory list 415, using the cursor 420. If the user clicks on the selected number, the web application causes a call to be placed (denoted in area 425) by communicating with call server system 150 through wrapper 122. The web application will direct call server 137 to connect the telephone at 555-1111 to the selected telephone at 555-2222. In one embodiment, the web application communicates call control commands directing call server 137 to place the call.

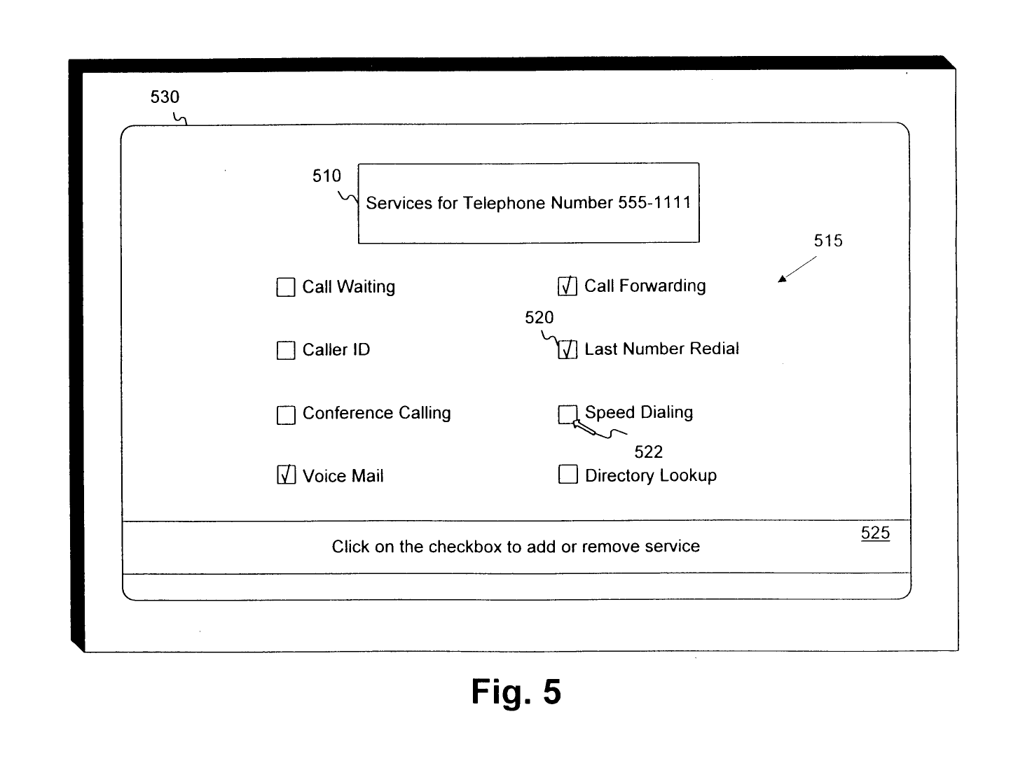

FIG. 5 shows an example of a web application graphical user interface 530 for a web browser running on PC 110. A screen title 510 shows that a user at telephone number 555-1111 is invoking a telephone services web application on his web browser. In this example, the web application allows the user to add or remove services for their telephone (denoted in area 525). The web application lists the services available 515 and allows the user to add or remove services by clicking on a checkbox 520 using the cursor 522. If the user clicks a checkbox, the web application communicates with call server system 150 through wrapper 122. The web application directs call server 137 to add the selected service, for example speed dialing, to the user's telephone at 555-1111. In one embodiment, the web application communicates service control commands to cause call server 137 to add or remove the selected service.

Web Browser Call

Referring again to FIG. 1, assume for purposes of example that a user at PC 110 wishes to call a person whose telephone is connected to PSTN 145. Assume further that telephony device 140 is the user's desk telephone, co-located with PC 110, that user interface 112 is a web browser executing on PC 110, and that web server 120 makes available on IP network 115 a web application for controlling call server 137. Although the web application is loaded from web server 120 which is connected to CTI server 130 in this example, the web application could be located on any web server connected to IP network 115, and the user could still communicate with call server 137 through wrapper 122.

Using web browser 112, the user accesses web server 120 with, for example, the URL address of the web server. Web browser 112 downloads a web application in the form of a Java applet. The web application applet, running on web browser 112, establishes a connection with call server 137 through wrapper 122 and CTI server 130. From the web application GUI on PC 110, the user sends the appropriate data to make a phone call between desktop telephone 140 and the destination telephone (not shown) connected to PSTN 145. The data may include information such as the user's number, the number to be called, and call control commands for web server 137.

In response to the data, call server 137 establishes a connection between telephone 140 and the destination telephone. In one embodiment, at this point, user telephone 140 rings and at the same time the destination telephone rings. Each of the telephones are connected when they are put offhook, and call server 137 concurrently sends two notify events to the web application to indicate that the user telephone 140 and destination telephone are connected. In another embodiment, user telephone 140 rings until the user puts the telephone offhook. Then, the destination telephone rings until it is put offhook, and call server 137 sends two notify events successively to the web application to indicate that the user telephone 140 and destination telephone are connected.

Wrapper Placement

The wrapper may be placed anywhere in a system that requires a communication path and format translation between web application data and a call server system data. The present invention may be implemented using one or more computer software programs or applications. As a software embodiment, the present invention may be executed on any processor communicatively connected, either directly or indirectly, to both an IP network and a call server system. One skilled in the art will recognize that other implementations, for example, as a hardwired device, are possible within the scope of the present invention, and may be placed similarly in the network environment.

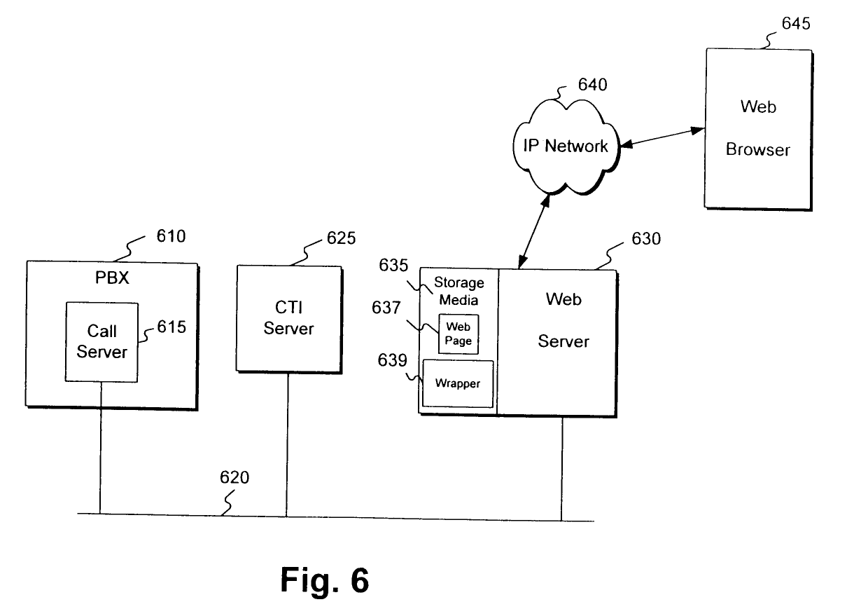

FIG. 6 shows another embodiment of a data network environment consistent with the principles of the present invention. In this embodiment, the elements of a legacy call server system, namely, PBX 610, call server 615, data network 620, and CTI server 625, remain unchanged.

PBX 610 comprises a call server 615. Call server 615 acts in a conventional manner, controlling telephone calls and telephony services, such as call forwarding and voice mail, in the PBX. Call server 615 is communicatively connected to data network 620.

Data network 620 may be any conventional network that allows communication between data processing systems connected to it. For example, data network 620 may be a Local Area Network (LAN) or Wide Area Network (WAN). Data network 620 is shown isolated from IP network 640. In other embodiments consistent with the principles of the present invention, data network 620 may be connected to IP network 640. CTI server 625 is communicatively connected to data network 620, and implements a computer telephony interface so that a data processing system accessing the CTI's API through the data network 620 may control call server 615.

Web server 630 is communicatively connected to data network 620 and to IP network 640. Web server 630 comprises a processor (not shown) and storage media 635. In this embodiment, storage media 635 includes a web page 637 and wrapper 639. Web page 637 comprises a Java applet web application for communicating with call server 615 through wrapper 639. Web server 630 executes wrapper 639, and makes web page 637 available over IP network 640. One skilled in the art will realize that an entity other than a web page 637 could be used to publish the interface to a web application for communicating with call server 615, within the scope of the present invention. For example, XML formatted data or a stub for a remote object could be used to provide users with a web application.

Web browser 645 is connected to IP network 640. In this embodiment, web browser 645 loads web page 637 from web server 630. Web page 637 includes a web application program, in this example a Java applet, which executes on web browser 645. The web application program communicates with call server 615 by transmitting data to wrapper 639 over IP network 640. The wrapper 639 translates the data and transmits it to the CTI server 625 via the data network 620. The CTI server communicates with the call server 615 over the data network 620. Call server 615 communicates with the web application program back along the same path.

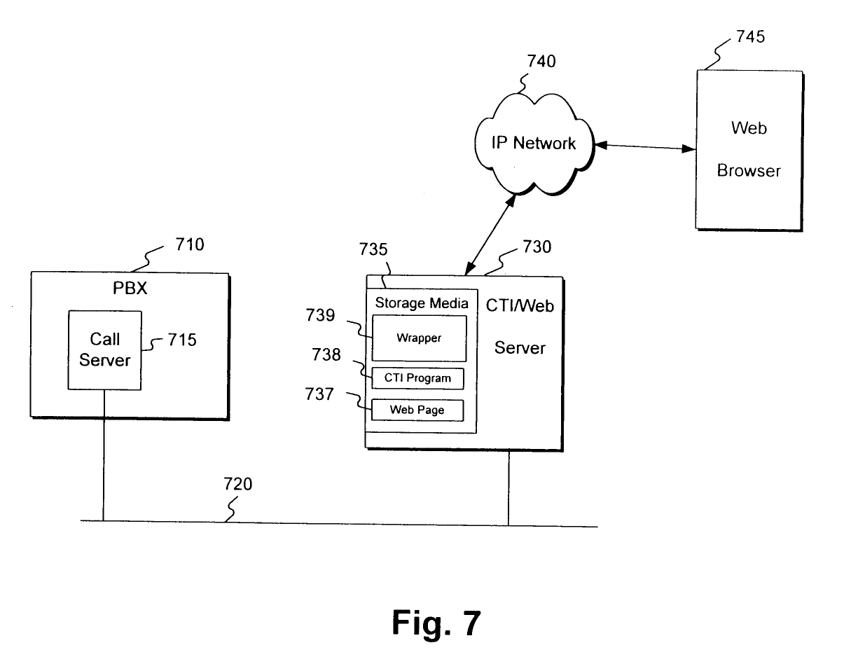

FIG. 7 shows another embodiment of a data network environment consistent with the principles of the present invention. In this embodiment, several conventional elements of a call server system, namely, PBX 710, call server 715, and data network 720, remain unchanged. CTI/web server 730, however, integrates the functions typically performed by a CTI and web server. One advantage of this approach is cost reduction of adding the wrapper to an existing call server system by utilizing an existing server.

PBX 710 comprises a call server 715, which controls calls and services in the PBX 710. Call server 715 is communicatively connected to data network 720. CTI/web server 730 is communicatively connected to a data network 720 and to an IP network 740. CTI/web server 730 comprises storage media 735. A wrapper 739, a standard CTI program 738, and a web page 737 are stored in storage media 735. In this embodiment, CTI/web server 730 executes wrapper 739 and standard CTI program 738, and makes web page 737 available over IP network 740.

Web browser 745 is connected to IP network 740. Web browser 745 loads web page 737 from CTI/web server 730. In this embodiment, web page 737 provides a Java applet web application which executes on web browser 745. The web application program indirectly communicates with call server 715 by communicating with wrapper 739 over IP network 740. Wrapper 739 communicates with CTI program 738 internal to CTI/web server 730. CTI program 738 communicates with call server 715 via data network 720. Thus, data can be transferred between the web application executing on web browser 745 and call server 715.

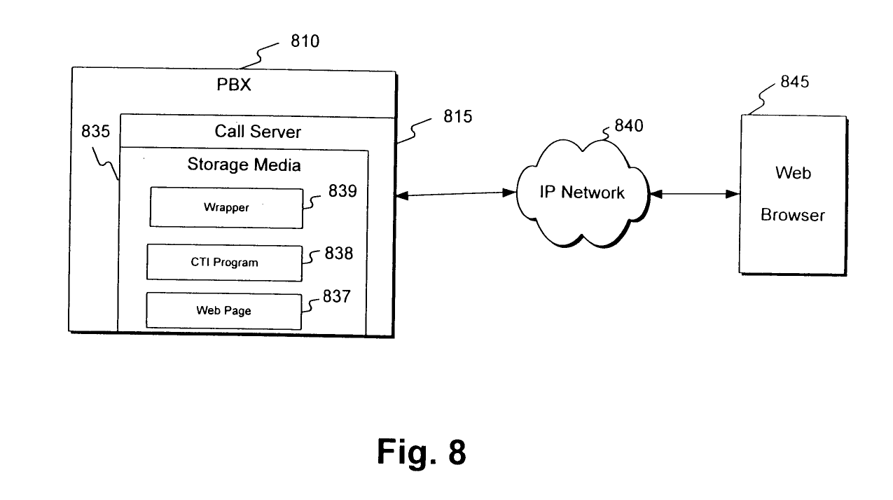

FIG. 8 shows yet another embodiment of a data network environment consistent with the principles of the present invention. In this embodiment, the call server system consists of a PBX 810 and a call server 815. Call server 815 connects to an IP network 840 and executes the wrapper 839. IP network 840 could, for example, be the World Wide Web. One advantage of this embodiment is that only one server is required, which already exists.

PBX 810 comprises a call server 815. Call server 815 is communicatively connected to IP network 840. Call server 815 comprises a processor and storage media 835. Wrapper 839, a standard CTI program 838, and web page 837 are stored in storage media 835. In this embodiment, call server 815 executes the wrapper 839, and the CTI program 838, and makes web page 837 available over IP network 840.

Web browser 845 is connected to IP network 840. Web browser 845 loads web page 837 from call server 815. Web page 837 provides a Java applet web application program which executes on web browser 845. The web application program communicates with the call server 815 using a communication channel that runs across IP network 840, through wrapper 839, through the CTI program 838, and to the call server's control and service functions.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1-34. (canceled)

35. A method performed by a wrapper for enabling a web application to communicate with a call server system, comprising:
providing a communication channel between the web application and the call server system; and
translating web application commands transferred from the web application to the call server system from a web application format into a call server system format.

36. The method of claim 35 wherein the translating web application commands further comprises translating a call control command.

37. The method of claim 36 wherein the translating a call control command further comprises translating a conference call control command.

38. The method of claim 35 wherein the translating web application commands further comprises translating a service control command.

39. The method of claim 35 further comprising translating call server commands transferred from the call server system to the web application from the call server system format into the web application format.

40. A wrapper apparatus for enabling a web application to communicate with a call server system comprising:
means for providing a communication channel between the web application and the call server system; and
means for translating web application commands transferred from the web application to the call server system from a web application format into a call server system format.

41. The apparatus of claim 40 wherein the means for translating web application commands further comprises:
means for translating a call control command.

42. The apparatus of claim 41 wherein the means for translating a call control command further comprises:
means for translating a conference call control command.

43. The apparatus of claim 40 wherein the means for translating web application commands data further comprises:
means for translating a service control command.

44. The apparatus of claim 40 further comprising:
means for translating call server commands transferred from the call server system to the web application from the call server system format into the web application format.

45. A computer program product comprising a computer usable medium having computer readable code embodied therein for enabling a web application to communicate with a call server system, comprising:
computer readable code for causing a computer to provide a communication channel between the web application and the call server system; and
computer readable code for causing a computer to translate web application commands transferred from the web application to the call server system from a web application format into a call server system format.

46. The computer program product of claim 45 wherein the computer readable code for causing a computer to translate web application commands further comprises:
computer readable code for causing a computer to translate a call control command.

47. The computer program product of claim 46 wherein the computer readable code for causing a computer to translate a call control command further comprises:
computer readable code for causing a computer to translate a conference call control command.

48. The computer program product of claim 45 wherein the computer readable code for causing a computer to translate web application commands further comprises:
computer readable code for causing a computer to translate a service control command.

49. The computer program product of claim 45 further comprising:
computer readable media for causing a computer to translate call server commands transferred from the call server system to the web application from the call server system format into the web application format.

50. A wrapper apparatus for enabling a web application to communicate with a call server system comprising:
a digital computer containing a communications circuit for providing a communication channel between the web application and the call server system; and
a circuit for translating web application commands transferred from the web application to the call server system from a web application format into a call server system format.

51. The apparatus of claim 50 wherein the circuit for translating web application commands further comprises:
a circuit for translating a call control command.

52. The apparatus of claim 51 wherein the circuit for translating a call control command further comprises:
a circuit for translating a conference call control command.

53. The apparatus of claim 50 wherein the circuit for translating web application commands further comprises:
a circuit for translating a service control command.

54. The apparatus of claim 50 further comprising
a circuit for translating call server commands transferred from the call server system to the web application from the call server system format into the web application format.

55. A system for web-based control of call server functions comprising:
a call server system;
a web application;
a user interface for directing the web application; and
a wrapper for providing a communication channel between the web application and the call server system and for translating web application commands transferred from the web application to the call server system from a web application format into a call server system format.

56. The system of claim 55 further comprising:
a web server for providing the web application to the user interface.

57. The system of claim 56 wherein the web application comprises:
an interactive web page from the web server.

58. The system of claim 56 wherein the web server comprises:
the wrapper.

59. The system of claim 55 wherein the user interface comprises:
a personal computer with a web browser.

60. The system of claim 55 wherein the call server system further comprises:
the wrapper.

61. The system of claim 55 wherein the call server system further comprises:
a computer telephony interface for communicating with the call server.

62. The system of claim 55 wherein the call server system further comprises:
a computer telephony interface server comprising a computer telephony interface.

63. The system of claim 62 wherein the computer telephony interface server comprises:
the wrapper.
